(19) United States
(12) Patent Application Publication
(10) Pub. No.: US 2015/0058006 A1
(43) Pub. Date: Feb. 26, 2015

(54) PHONETIC ALIGNMENT FOR USER-AGENT DIALOGUE RECOGNITION

(71) Applicant: Xerox Corporation, Norwalk, CT (US)

(72) Inventor: Denys Proux, Vif (FR)

(73) Assignee: Xerox Corporation, Norwalk, CT (US)

(21) Appl. No.: 13/974,515

(22) Filed: Aug. 23, 2013

(51) Int. Cl. G10L 15/26

(52) U.S. Cl. CPC G10L 15/26
USPC 704/235

(57) ABSTRACT

A method for speech to text transcription uses a knowledge base containing solution descriptions, each describing, in words, a solution to a respective problem. An audio recording of a dialogue between an agent and a user in which the agent had access to the knowledge base is received. A sequence of phonemes based on the agent's part of the audio recording is identified and from this, a preliminary transcription is made which includes a sequence of words recognized as corresponding to phonemes in the identified sequence of phonemes together with any unrecognized phonemes from the phoneme sequence that are not recognized as corresponding to one of the recognized words. The preliminary transcription is revised by replacing one or more of the unrecognized phonemes with a word or words from a solution description that includes words which match adjacent words of the sequence of recognized words.

### BACKGROUND

The exemplary embodiment relates to voice recognition and finds particular application in connection with speech-to-text conversion for improving transcription of user-agent conversations regarding a user's problem for which a knowledge base containing problems and corresponding solutions is available to the agent.

Speech-to-text (STT) conversion technology is widely used for conversion of sounds from the human voice to an electronic text recording. There are various applications for the technology, such as allowing mobile phone users to dictate a query that is then sent to a search engine that will retrieve information. Other types of applications allow dictating text that is converted into an electronic format that may be processed by text editors or by other applications using electronic text as input.

In order to perform efficiently, such SST systems are usually customized for a give user. In call centers that rely on agents answering user questions through telephone conversations, it would be advantageous to be able to convert these discussions into an electronic format that could be mined through analytics or used for other purposes. Current speech-to-text software fails to deliver appropriate efficiency for this task. While efficiency could be improved by training the system to recognize the voice of the agent, particularly the way he pronounces some predefined words, and customizing the system to a specific domain, such approaches are difficult to apply in the context of transcribing conversations between agents and users over the phone in call centers. For example, agents do not have time to train the system to recognize their voice and turnover among agents tends to be high. Another problem is that it is not possible to train the system for recognizing the voice of the user, who is generally a customer. There may also be a very domain-specific vocabulary used in the conversations. It is time-consuming to build a very specific language model that fits the specific domain. For example, the vocabulary used in call centers for administrative support is quite different from the one used to resolve issues for a mobile phone company or to address technical issues related to printers or mobile phones. Companies producing STT systems generally do not have access to the information, e.g., due to privacy issues.

It is not surprising therefore, that experiments made on call center phone call transcriptions indicated an efficiency of about 60% for agent voice recognition and 25% for user voice recognition, meaning that only one word in four is recognized. These results are far too sparse to be of real use.

There remains a need for a system and method adapted to transcription of such conversations.

### INCORPORATION BY REFERENCE

The following references, the disclosures of which are incorporated herein by reference in their entireties, are mentioned:

U.S. Pat. No. 8,204,748 issued Jun. 19, 2012, and U.S. Pat. No. 8,244,540, issued Aug. 14, 2012, entitled SYSTEM AND METHOD FOR PROVIDING A TEXTUAL REPRESENTATION OF AN AUDIO MESSAGE TO A MOBILE DEVICE, by Denys Proux, et al.

U.S. application Ser. No. 13/849,630, entitled ASSISTED UPDATE OF KNOWLEDGE BASE FOR PROBLEM SOLVING, by Denys Proux, filed Mar. 25, 2013.

### BRIEF DESCRIPTION

In accordance with one aspect of the exemplary embodiment, a method for speech to text transcription includes providing access to a knowledge base containing solution descriptions, each solution description including a textual description of a solution to a respective problem. A preliminary transcription of at least an agent's part of an audio recording of a dialogue between the agent and a user in which the agent had access to the knowledge base is generated. The generating includes identifying a sequence of phonemes based on the agent's part of the audio recording, and based on the identified sequence of phonemes, generating the preliminary transcription, the preliminary transcription including a sequence of words recognized as corresponding to phonemes in the sequence of phonemes and unrecognized phonemes from the phoneme sequence that are not recognized as corresponding to one of the recognized words. The preliminary transcription is revised, which includes replacing unrecognized phonemes with words from a solution description, where the solution description includes words which match words from the sequence of recognized words. At least one of the generating of the preliminary transcription and the revising of the preliminary transcription may be performed with a processor.

In accordance with another aspect of the exemplary embodiment, a system for speech to text transcription includes a speech to text decoder for generating a preliminary transcription of at least an agent's part of an audio recording of a dialogue between the agent and a user, the agent having access to an associated knowledge base of solution descriptions, each solution description including a textual description of a solution to a respective problem. The decoder is configured for identifying a sequence of phonemes based on the agent's part of the audio recording, and based on the identified sequence of phonemes, generating the preliminary transcription. The preliminary transcription includes a sequence of words recognized as corresponding to phonemes in the sequence of phonemes and unrecognized phonemes from the phoneme sequence that are not recognized as corresponding to one of the recognized words. A revision component revises the preliminary transcription. The revision component is configured for comparing recognized words in the preliminary transcription with words in solution descriptions in the knowledge base to identify candidate solution descriptions which each include a sequence of text which includes words which are determined to match at least some of the identified words in the preliminary transcription and, using a phoneme sequence corresponding to a sequence of text in one of the candidate solution descriptions, replacing unrecognized phonemes in the preliminary transcription with at least one word of the sequence of text in the candidate solution description to generate a revised transcription. A processor implements the revision component.

In accordance with another aspect of the exemplary embodiment, a method for providing a system for speech to text transcription includes, for each of a set of solution descriptions in a knowledge base which includes a textual description of a solution to a respective problem with a device, associating the solution description with a sequence of phonemes corresponding to at least a part of the textual description. The method further includes providing access to a speech to text converter which is configured for generating a preliminary transcription of at least an agent's part of an audio recording of a dialogue between the agent and a user in which the agent has access to the knowledge base. The generating includes identifying a sequence of phonemes based on the agent's part of the audio recording, and based on the identified sequence of phonemes, generating the preliminary transcription. The preliminary transcription includes a sequence of words recognized as corresponding to phonemes in the sequence of phonemes and any unrecognized phonemes from the phoneme sequence that are not recognized as corresponding to one of the recognized words. Instructions are provided for revising the preliminary transcription when there are unrecognized phonemes from the phoneme sequence. The instructions provide for replacement of unrecognized phonemes with text from a solution description which includes words from the sequence of recognized words. A processor is provided for associating each solution description with a sequence of phonemes.

### BRIEF DESCRIPTION OF THE DRAWINGS

FIG. 1 is a simplified representation of an environment in which a transcription system operates in accordance with one aspect of the exemplary embodiment;

FIG. 2 is a functional block diagram of the transcription system of FIG. 1;

FIG. 3 illustrates a method for transcribing a voice recording in accordance with another aspect of the exemplary embodiment; and

FIG. 4 illustrates a transcription process for an agent's part of the dialogue.

### DETAILED DESCRIPTION

Aspects of the exemplary embodiment relate to a system and method for transcribing dialogue between a user seeking a solution to a problem and an agent which has access to a knowledge base which provides solutions to problems of the type presented by the user. In the exemplary embodiment, phoneme encodings of words from problem—solution descriptions in the knowledge base are used to find alignments with phonetic transcriptions of misrecognized words from user-agent transcriptions in order to fill gaps in the transcription.

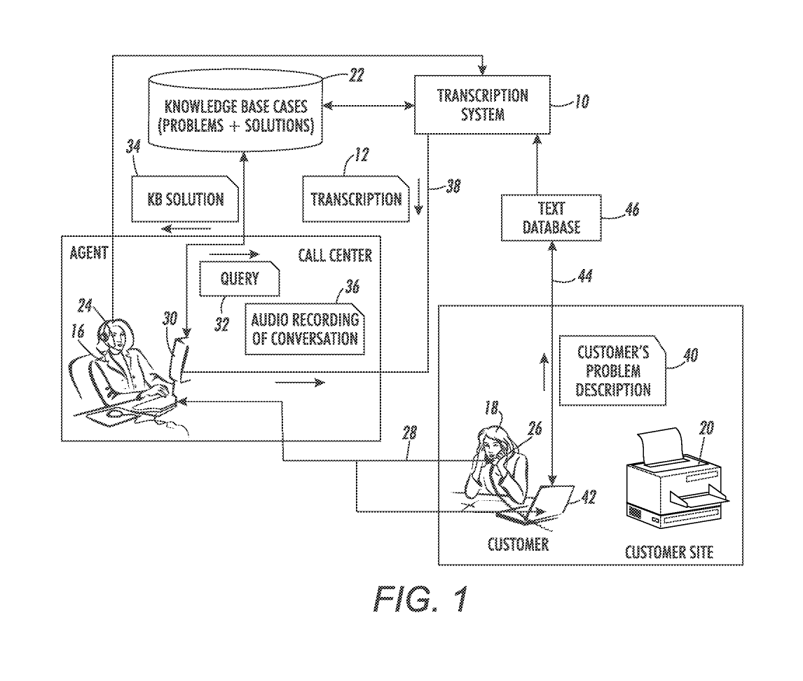

With reference to FIG. 1, a transcription system 10 provides a transcription 12 of a conversation between a call center agent 16 and a user 18, using speech-to-text conversion. The user is a person wishing to solve a problem, for example, a problem with a physical device 20 or with a service. The agent may be located in a call center which responds to customer phone calls on behalf of a company which markets or leases devices, such as the device 20, or provides services to customers, such as the exemplary user. The agent may take many calls from users in a given day and provide solutions to the user's problem using stored information. Specifically, a knowledge base (KB) 22 stores descriptions of solutions to known problems with the device or service. The exemplary knowledge base 22 is arranged as a set of cases, each case including a textual description of a problem and a textual description of one or more known solutions to the problem. The descriptions may be indexed and may be accessed, for example using a textual query input by the agent.

The illustrated device 20 is a printer, although any electromechanical device, such as a computer, camera, telephone, vehicle, household device, medical device, or other device is also contemplated. In another embodiment, the problem may relate to the user's health, the agent may be a heath care professional, and the knowledge base 22 may store health problems and common solutions for treatment of the problem.

Using voice communication devices, such as the illustrated telephones 24, 26, the agent and customer communicate via a wired or wireless link 28, such as a telephone line, VOIP connection, mobile phone communication system, combination thereof, or the like. Based on the phone conversation, the agent accesses the knowledge base 22, e.g., using a computing device 30 to retrieve solutions to the problem. For example, the agent 16 enters a query 32 via a search engine which retrieves one or more relevant problem descriptions and their solutions 34 and relays one or more of these solutions to the customer as part of the conversation. An audio (voice) recording 36 of the conversation is made, e.g., by the agent's communication device 24 and/or computing device 30 and is sent via a wired or wireless link 38 to the transcription system 10, which outputs the transcription 12 of the conversation.

The user may also provide a textual (written) description 40 of the problem, either before or during the conversation, which may be employed by the system 10 to resolve errors in the transcription of the audio recording 36 of the conversation (or of another conversation relating to similar subject matter). For example, the user prepares and sends a text communication 40, such as an email, live web chat, or SMS, to the agent from the user's computing device 42, which is received via a wired or wireless link 44 and stored in a database 46 of text communications accessible to the transcription system 10. Text database 46 may thus include a corpus of emails reflecting discussions between users and agents about problems to be solved.

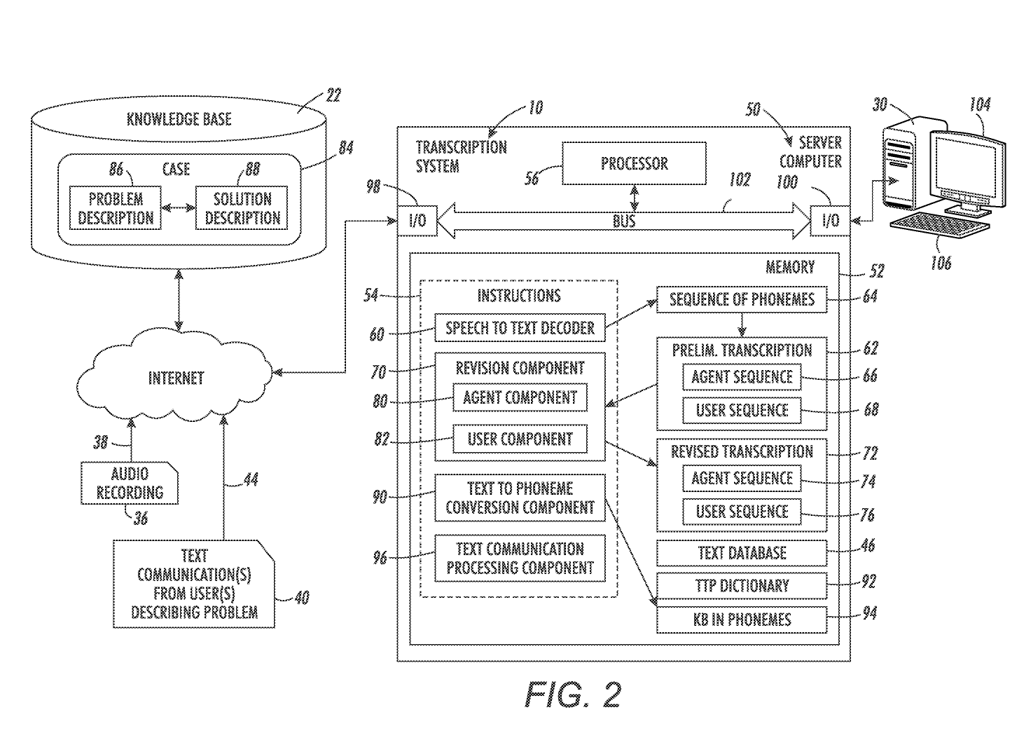

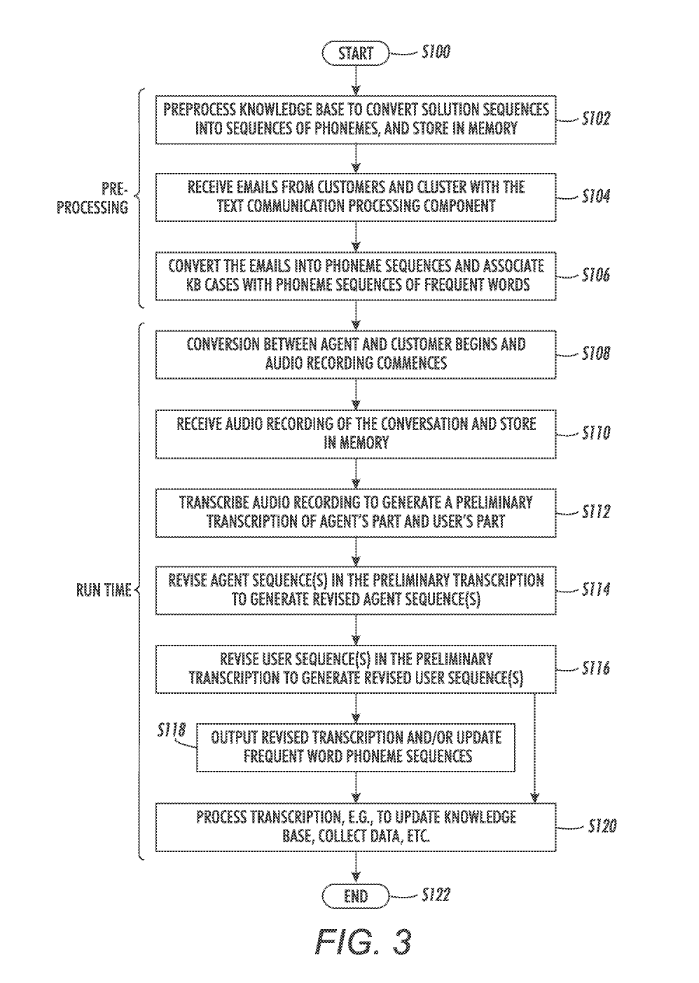

With reference also to FIG. 2, the transcription system 10 may be hosted by one or more computing devices, such as the illustrated server computer 50. Non-transitory memory 52 of the system 10 stores instructions 54 for performing the method described below with reference to FIG. 3, which are executed by an associated computer processor 56. The system 10 includes, or accesses from remote memory, a speech-to-text (STT) decoder 60 for converting speech into text. The decoder 60 may be any suitable commercially-available or custom SST tool. Given a voice recording 36, the decoder creates a preliminary transcription 62. Specifically, the decoder 60 converts the recording into one or more sequences 64 of phonemes, together with associated time stamps for start and end of each phoneme, and from the sequence 64, identifies a sequence of recognized words, with associated time stamps for start and end of each recognized word and possibly one or more gaps in the word sequence where the decoder was not able to confidently recognize one or more words from the phonemes detected. The decoder retrieves the phonemes from the phoneme sequence for the words it was not able to identify. The resulting preliminary transcription 62 may thus contain words as well as one or more phonemes from the original sequence of phonemes 64 that the decoder 60 was unable to transcribe. The preliminary transcription 62 may include one or more preliminary agent sequences 66 (a preliminary transcription of the agent's part of the conversation) and one or more preliminary user sequences 68 (a preliminary transcription of the user's part of the conversation).

A revision component 70 takes as input the preliminary transcription 62 and outputs a revised transcription 72. The revised transcription 72 may include one or more revised agent sequences 74 (a revised transcription of the agent's part of the conversation, based on agent sequence 66) and/or one or more revised user sequences 68 (a revised transcription of the user's part of the conversation, based on user sequence 68). The revision component 70 utilizes stored textual information relating to the device 20 in order to resolve errors in the transcription. In particular, an agent-side revision component (agent component) 80 resolves untranscribed phonemes in the preliminary agent sequence(s) 66 to provide a revised transcription 74 of these sequences, using information extracted from the knowledge base 12 descriptions of problems and related solutions. A user-side revision component (user component) 82 resolves untranscribed phonemes in the preliminary user sequence(s) 68 to provide a revised transcription 76 of these sequences, using information extracted from the database 46 which contains the corpus of emails by customers (and agents) about problems to be solved.

The knowledge base 22 may be arranged into a set of cases 84, each with an associated case identifier. Each case may include a textual problem description 86 and one or more solution descriptions 88, each describing, in a sequence of steps, how to resolve the respective problem with the device. The agent 16 often reads from one of the solution descriptions 88 during the conversation with the customer 18.

For examples of exemplary knowledge bases 22, see, for example, US Pub. Nos. 20060197973, published Sep. 7, 2006, entitled BI-DIRECTIONAL REMOTE VISUALIZATION FOR SUPPORTING COLLABORATIVE MACHINE TROUBLESHOOTING, by Castellani, et al.; 20070192085, published Aug. 16, 2007, entitled NATURAL LANGUAGE PROCESSING FOR DEVELOPING QUERIES, by Roulland, et al.; U.S. Pub. No. 20080091408, published Apr. 17, 2008, entitled NAVIGATION SYSTEM FOR TEXT, by Roulland, et al.; 20080294423, published Nov. 27, 2008, entitled INFORMING TROUBLESHOOTING SESSIONS WITH DEVICE DATA, by Castellani, et al.; and 20100229080, published Sep. 9, 2010, entitled COLLABORATIVE LINKING OF SUPPORT KNOWLEDGE BASES WITH VISUALIZATION OF DEVICE, by Roulland, et al., the disclosures of which are incorporated herein by reference in their entireties.

The system 10 may further include a text-to-phoneme (TTP) conversion component 90 which receives text (as a sequence of words) as input and outputs a sequence of phonemes corresponding to the words of the input text. As in conventional text, each word may be spaced from the next by a blank space and/or by punctuation. The punctuation may be ignored in the conversion (in some embodiments, periods may be identified and used to subdivide the text into a sequence of steps). Numbers may be converted to their textual equivalents (e.g., “103” is converted to “one hundred and three”). The conversion component 90 may access a text-to-phoneme dictionary 92 containing single words (and optionally, longer phrases) and for each word (or phrase), a corresponding phoneme sequence. Each phoneme sequence includes at least one (and for at least some words, more than one) phoneme. The conversion component 90 converts text content of the knowledge base 22 (e.g., the solution descriptions 88 and optionally also the problem descriptions 86) into sequences of phonemes, which may then be stored as sequences of phonemes together with a respective case ID in a database of converted KB sequences 94. For example, an entire solution description 88 may be linked to a respective sequence of phonemes. Alternatively, each step or each sentence in a solution description 88 may be linked to a respective sequence of phonemes, where each sequence may include, for example, one, two, or more steps and generally less than ten steps. In general, the converted KB sequences 94 each correspond to a text sequence which is several words in length, for example, at least a sentence in length. The phoneme database 94 may be incorporated into the knowledge base 22, e.g., in a remote non-transitory memory, or stored in system memory 52 or other memory accessible to the system 10.

A text communication processing component 96 may cluster the text communications 40 in the corpus 46 into clusters based on word similarity and may assign to each cluster a solution description ID corresponding to the most similar solution description 88 or otherwise link each the text communications to a respective solution description 88. From the cluster of communications linked to a given solution description a set of frequent words is identified. These words may be processed by the TTP conversion component 90 to provide a set of frequent words and their corresponding phoneme sequences for each solution ID. It should be noted that in the case of the text communications 40, rather than provide phoneme sequences which each correspond to an entire sentence, in the exemplary embodiment, the phoneme sequences each correspond to only a single word. However, in some embodiments, the phoneme sequences may correspond to fairly short word sequences that are longer than one word, e.g., n-grams, such as bigrams where n is 2, or in some embodiments, more than 2, e.g., n may be up to 5, or up to 3.

The transcription system 10 may further include one or more input/output (I/O) devices 98, 100 for communication with external devices via wired or wireless links, such as the Internet. Hardware components 52, 56, 98, 100 of the system may communicate via a data/control bus 102.

The computer implemented system 10 may include one or more computing devices 50, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 52 may represent any type of non-transitory computer readable medium such as random access memory (RAM), read only memory (ROM), magnetic disk or tape, optical disk, flash memory, or holographic memory. In one embodiment, the memory 52 comprises a combination of random access memory and read only memory. In some embodiments, the processor 56 and memory 52 may be combined in a single chip. Memory 52 stores instructions for performing the exemplary method as well as the processed data 62, 72, 94. The network interface 98, 100 allows the computer to communicate with other devices via a computer network, such as a local area network (LAN) or wide area network (WAN), or the internet, and may comprise a modulator/demodulator (MODEM) a router, a cable, and and/or Ethernet port.

The digital processor 56 can be variously embodied, such as by a single-core processor, a dual-core processor (or more generally by a multiple-core processor), a digital processor and cooperating math coprocessor, a digital controller, or the like. The digital processor 56, in addition to controlling the operation of the computer 50, executes instructions stored in memory 54 for performing the method outlined in FIG. 3.

The user's computing device 42 and agent's computing device 30 can be similarly configured to the server computer 50, with memory and a processor. In addition the user's/agent's computer may include a display device 104, such as an LCD screen or computer monitor, and a user input device 106, such as one or more of a keyboard, keypad, touch screen, cursor control device, or the like, for inputting user commands to the respective computer processor. Some of the software components of the system 10 may be at least partly resident on these devices.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 2 is a high level functional block diagram of only a portion of the components which are incorporated into a computer system. Since the configuration and operation of programmable computers are well known, they will not be described further.

FIG. 3 illustrates a transcription method which may be performed using the illustrated system. The method begins at S100.

At S102, if not already performed, the knowledge base 22 may be preprocessed by the TTP component 90 (using the text-to-phoneme dictionary 92) to convert solution descriptions 88 into respective sequences of phonemes, which are stored in memory 64.

At S104, text communications, such as emails 40, may be received from customers, and clustered by the text communication processing component 96. A set of words representative of commonly used words in a cluster may be associated with the corresponding case in the knowledge base.

At S106, the commonly used words identified in the emails 40 may be converted into phoneme sequences by the TTP component 90, using the TTP dictionary 92. In this way, a set of phoneme sequences representative of commonly used words in a cluster may be associated with the corresponding case in the knowledge base.

This ends the preprocessing stage.

At S108, a conversation between an agent 16 and a user 18 begins and audio recording commences.

At S110, an audio recording 36 of the conversation between the agent and the user is received by the system 10 and is stored in memory, such as memory 52. The audio recording 36 may identify the agent's parts and the user's parts of the conversation, e.g., by using the phone system at the call center to distinguish between signals coming from the call center (agent's) and those coming from outside (user's). In some embodiments, only the agent's part of the dialogue is stored for processing.

At S112, the audio recording 36 of the conversation is transcribed by the SST decoder 60 to generate a preliminary transcription 62 comprising a set of one or more text sequences tagged as agent sequences 66 and a set of one or more text sequences tagged as user sequences 68. In the sequences, time stamps are associated with the recognized words and with any unrecognized phonemes that the SST decoder 60 has not transcribed.

At S114, the agent component 80 of the revision component 70 revises the agent sequence(s) 66 in the preliminary transcription to generate revised agent sequence(s) 74. This includes comparing each preliminary agent sequence that contains unrecognized sequences of phonemes with sequences of phonemes 94 generated from the KB content 86, 88 where matching words are identified. Any agent sequences that do not contain unrecognized phonemes can be ignored.

At S116, the user component 82 of the revision component 70 revises the user sequence(s) 68 in the preliminary transcription to generate revised user sequence(s) 76. This includes identifying any sequences of phonemes that have not been recognized by the SST decoder 60. The user component 82 identifies the frequent words associated with the relevant KB case(s) identified during S114 and compares each of the unrecognized sequences in the user sequence 68 to the phoneme sequences of these frequent words to determine whether there is a match between any of the unrecognized sequences of phonemes and the frequent word phoneme sequences and replaces the unrecognized sequences with the matching frequent words. Any user sequences that do not contain unrecognized phonemes can be ignored.

At S118, a revised transcription 72, or part thereof, based on the revised sequences 74, 76, may be output by the system 10. Any email or other text communications 40 received during the conversation may be added to the email database 46 and processed at S106.

At S120, the revised transcription 72, or part of it, may be processed to generate information based on the text of the transcription. For example, the transcription may be used to track agent efficiency, detect new trends, trigger actionable processes, perform various analytics based studies, and the like. In one specific embodiment, the transcription 72 may be used by a system as described in U.S. application Ser. No. 13/849,630, for updating the knowledge base 22 with new solutions and/or problem descriptions, based at least in part on the transcription 72. In another embodiment, each revised agent sequence of words 74 may be compared with the solution description of words 88 in the KB which most closely matches it (assuming it meets at least a threshold similarity between the words). From the comparison, it may be determined whether the agent followed the text or did not follow it accurately, for example, if the agent omitted words which, if spoken, may have helped the customer to implement the solution on the device 20 or if the agent mispronounced words so that the conversation is not easily transcribed and also perhaps not fully understood by the customer. In another embodiment, the transcriptions may also be used to collect data on the types of problems that are being raised by customers for a particular device.

The method ends at S122, or may return to S108 when a new conversation commences.

The method illustrated in FIG. 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 50, (for example, an internal hard drive of RAM), or may be separate (for example, an external hard drive operatively connected with the computer 50), or may be separate and accessed via a digital data network such as a local area network (LAN) or the Internet (for example, as a redundant array of inexpensive of independent disks (RAID) or other network server storage that is indirectly accessed by the computer 50, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the transcription method. As will be appreciated, while the steps of the method may all be computer implemented, in some embodiments one or more of the steps may be at least partially performed manually.

As will be appreciated, the steps of the method need not all proceed in the order illustrated and fewer, more, or different steps may be performed.

Further details of the system and method will now be provided.

### Pre-Processing

In the exemplary system, the STT tool 60 generates a transcription of user-agent voices for the words that are recognized words (e.g., by matching with an available language model). Later, information is used from existing problem-solution descriptions inside the knowledge base (along with, in some cases, email discussions) to estimate the likely words in between the recognized words. The use of phonetic transcriptions of words inside the knowledge base 22 serves to bridge the gap with the phonetic transcription of the unrecognized words in the agent's part of the conversation, while text communications from prior customers seeking support provide frequent words which serve to bridge the gap with the phonetic transcription of the unrecognized words in the user's part of the conversation.

1. Phonemization of the Knowledge Base (S102)

Words can be pronounced several ways. In most dictionaries (and more specifically those dedicated to learning a foreign language) words are described, along with their definition or translation, with their standard pronunciation. This means that the word is encoded using a sequence of symbols referring to phonemes (the way each sound is pronounced). There are several existing phoneme alphabets such as the ARPAbet and the International Phonetic Alphabet (IPA) which can be used herein, although it is also contemplated that a different alphabet may be used In general the alphabet that is used by the SST decoder 60 is the same one as is used by the TTP conversion component 90.

Since there may be several ways to pronounce a word, a single word may have several possible encodings in the dictionary 92. For example, the word “water” can be encoded (using the ARPAbet encoding) as [W] [AO1] [DX] [ER] for U.S. English pronunciation or [W] [A] [T] [ER] for U.K. English pronunciation.

The phonemization of the knowledge base 22 may include encoding each word appearing in each sentence of the knowledge base into its phonetic notation. In the case that there are several possibilities to encode a word, then the N most frequent forms may be encoded, e.g., using a Finite State Transducer for efficiency. Then for each solution description 88, or step thereof, a phoneme sequence made up of the sequences of the words is generated. Where a word has several possible phoneme sequences, this may result in more than one sequence being stored, or a single sequence in which one or more of the words has two or more alternative phoneme sequences.

2. Processing of Text Communications (S104, S106)

The corpus 46 of email and other text communications 40 can be processed as follows. First, clusters of users' emails are created, thereby grouping them according to the provided answer so that all emails with the similar answer are grouped together (S104). All stop words are then removed from the texts (e.g., determiners, pronouns, etc.). Duplicate words are removed. For each remaining word in each cluster, a phonetic encoding is generated (S106). This provides a set of words that are commonly used in describing a given problem, together with their respective phoneme sequences.

### Run Time

There are two separated objectives which may be separately addressed by the exemplary system: the transcription of what the agent says and the transcription of what the user says.

1. Speech to Text Decoding (S112)

The SST decoder 60 aims to produce a semantically disambiguated output from recorded speech. When a person speaks into a microphone or telephone, the act of speaking produces a sound pressure wave which forms an acoustic signal. The microphone or telephone receives the acoustic signal and converts it to an analog signal which is converted to a digital signal for storage in computer memory. Common decoders 60 useful herein extract feature vectors from the digital sound recording. Only certain features of a person's speech are regarded as being helpful for decoding. These features allow a speech recognizer to differentiate among the phonemes (patterns of vowels and consonants) that are spoken for each word. Feature extraction includes extracting characteristics of the digital signal, such as energy or frequency response, augmenting these measurements with some perceptually-meaningful derived measurements (i.e., signal parameterization), and statistically conditioning these numbers to form observation vectors.

Once the feature vectors have been generated from the input sound, the next step is to recognize words from these vectors. To do so, an alignment process is performed between the data carried by the feature vectors and an acoustic model. Acoustic models can be either composed of word models or phoneme models. Word models include each of the phonemes produced for an entire word. However, word models tend not to be effective when there is a large vocabulary. Phoneme models contain the smallest acoustic components of a language.

In phonetic notation, the pronunciation of a word is described using a string of symbols that represent the phonemes. The phonemes are drawn from a finite alphabet of phonemes. A phoneme is a speech sound and there are generally more phonemes than letters in the common alphabets. For example, the English spoken language is composed of about 46 phonemes. Specific phoneme notations have been developed, such as the International Phonetic Alphabet (IPA). Another alphabet designed specifically for American English (which contains fewer phonemes than those available in the IPA alphabet) is the ARPAbet, which is composed only of ASCII symbols. See Shoup, J. E., “Phonological Aspects of Speech Recognition,” in Lea, W. A. (Ed.), Trends in Speech Recognition, pp. 125-138 Prentice-Hall, Englewood Cliffs, N.J. (1980). Each of these systems includes a finite set of phonemes from which the phonemes representative of the sounds are selected by the phoneme model.

Given a sequence of phonemes, the next step is a search for the most probable word matching the sequence of phonemes in a language model. The surrounding words are also considered in a search for the most likely word sequence. Speech recognition typically uses a hierarchical Viterbi beam search algorithm for decoding because of its speed and simplicity of design. See, for example, Deshmukh N., Ganapathiraju A., Picone J., “Hierarchical Search for Large Vocabulary Conversational Speech Recognition: working toward a solution to the decoding problem,” IEEE Signal Processing Magazine, vol. 16, no. 5, pp. 84-107 (September 1999); and Huang X, Acero A., and Hon H. H., “Spoken Language Processing—A Guide to Theory, Algorithm, and System Development,” Prentice Hall, Upper Saddle River, N.J. (2001)

When using search techniques, pruning is typically used to remove unlikely paths from consideration. In Viterbi pruning, the pruning takes place at the lowest level after evaluation of the statistical model. Paths with the same history can be compared—the best scorer is propagated and the other is deleted. An efficient storage scheme is used so that it is only necessary to compare a small number of data elements to determine those that are comparable. Recognition systems use many forms of pruning. In challenging environments, such a conversational speech collected over noisy telephone lines, an aggressive pruning may be used to avoid exceeding the physical memory capacities of the computer.

The speech to text system may include a language model that includes natural language processing components to predict or to disambiguate possible words according to the context. See, also, U.S. Pat. No. 8,401,847, issued Mar. 19, 2013, entitled SPEECH RECOGNITION SYSTEM AND PROGRAM THEREFOR, by Jun Ogata, et al., the disclosure of which is incorporated herein by reference, which determines pronunciation as an aid to disambiguation.

Training processes may be applied to improve the alignment between feature vectors and the acoustic models. Training can also be applied to improve the prediction of words according to the context. However, the exemplary method does not require training with the agent's or user's voice to be performed.

While many conventional SST decoders 60 output only the words that the system has recognized, sometimes with gaps substituted for the unrecognized phonemes, in the present system and method, the unrecognized phonemes are recovered from the original phoneme sequence generated by the decoder and, based on their time stamps, are inserted into the output text at the appropriate positions to provide a composite sequence of words and phonemes.

2. Transcription of What the Agent Says (S112, 114)

This method assumes that part of what the agent says is based on the content of the knowledge base 22. The method includes analyzing the dialogue between the agent and the user. The dialogue may proceed generally as follows:

a) User: provides a description of the problem

b) Agent: refines the problem to identify a list of symptoms

c) User: agrees on the symptoms or iterates on step b

d) Agent: proposes a solution (the agent may read loudly the solution, as described in the knowledge base 22).

It is thus expected that the words said by the agent at step d) should appear in the knowledge base 22, and be in the same order as the spoken words. Therefore, in the exemplary method, the revision component 70 attempts to recover the missing words appearing in the STT transcription 66 of that part of the dialogue. This step assumes that the content of the knowledge base has been “phonemized” (S102) and stored in memory.

In the exemplary method, the revision component 80 computes a probability that the unrecognized phonemes in the preliminary transcription match a sequence of one or more phonemes corresponding to one or more intervening words of a solution description, the intervening word(s) being located between first and second words that match first and second recognized words occurring before and after the unrecognized phonemes in the preliminary transcription (the computation is repeated where there is more than one sequence of unrecognized phonemes). As used herein, the term “matching” does not require an exact match between the words or phoneme sequences under consideration but implies that a suitable threshold on similarity has been met.

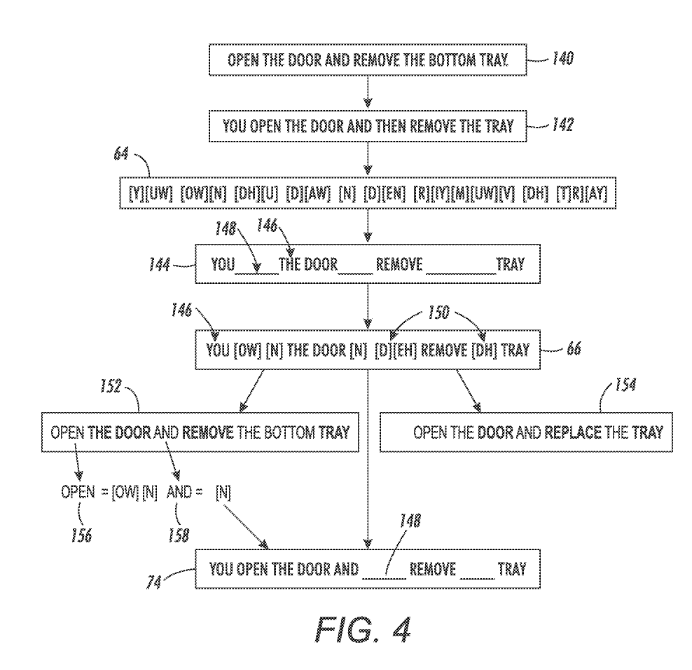

FIG. 4 illustrates the process in one exemplary embodiment. The agent may, in step d, read from a solution description 88 which includes a step 140 which as written states: Open the door and remove the bottom tray. The agent modifies the text slightly, and speaks the sequence 142: You open the door and then remove the tray. The speech detector analyses the recording of the spoken sequence and converts it to a sequence of phonemes, as illustrated at 64, from which a sequence 144 of words 146, which may include one or more gaps 148, is generated. Using the time stamps of the recognized words, sequences 150 of unrecognized phonemes that are temporally aligned with the gaps are inserted into the gaps 148. These unrecognized phonemes are compared with sequences of phonemes representing solution description steps 152, 154, etc. from the knowledge base containing words (shown in bold) that match recognized words 146 in the generated preliminary agent sequence 66.

The matching solution description steps 152, 154 may be filtered to identify solution description steps 152, 154 where the matching words are spaced by no more than a threshold gap, e.g., measured in number of words or phonemes. Other methods of identifying one, two or more candidate solution steps that are a potential match with the sequence 66 are also contemplated. From these candidate matching solution description steps 152, 154, a most probable matching solution description step 152 is identified and used to replace one or more of the unrecognized phonemes with respective aligned words or sequences of words 156, 158 from the solution description step 152, e.g., where a threshold similarity between the respective phoneme sequences is found. There may still be unrecognized phonemes, such as the sequences [D][EH] and [DH] in the example, which can be replaced with gaps 148 in the final output 74.

The method for generating a transcription 74 of the agent's side of the conversation may include implementing a sequence of steps as shown in ALGORITHM 1:

Algorithm 1

Apply decoder to the recorded voice of an agent to
generate:

A sequence of recognized phonemes + associated time
stamps (start phoneme, end phoneme): APL ([APL-
Phoneme-0, APL-0-start, APL-0-end], ... [APL-Phoneme-n,
APL-n-start, APL-n-end])
A sequence of recognized words + associated time
stamps (start word, end word): AWL ([AWL-Word-0, AWL-
0-start, AWL-0-end], ... [AWL-Word-n, AWL-n-start, AWL-
n-end])

Apply for each word i and word i+1 appearing in the list
AWL do:

Search for a similar pair of words appearing inside
the knowledge base (KB).
For each match found inside the KB do:

Keep as candidate only sequences WordSeq of words
from the KB where word i and word i+1 are
separated by no more than k words.
For each candidate sequence of words do: apply
ComputeFillGapLikelihood (WordSeq) => (L,
WordSeq, Sol-ID).
Record in a list LC of valid candidates
Likelihood L above threshold T along with the
related Solution ID (Sol-ID) and the sequence
(WordSeq) of missing words between Word i and
Word i+1 retrieved from the KB.

In more detail, the method includes applying the STT decoder 60 to the recorded voice of an agent to generate a sequence APL of recognized phonemes and associated time stamps that identify the start time of the phoneme and the end time of each phoneme. The decoder is then used to generate a sequence AWL of recognized words and associated time stamps based on the recognized phonemes (S112).

Then at S114, for each word word i and the next word word i+1 appearing in the sequence AWL, the method includes searching for the same (or similar) words appearing in the knowledge base 22. Similar words may be those for which there is at least a threshold on similarity, computed by comparing the characters of the two words, e.g., using the Levenshtein distance as a similarity measure, and/or by identifying words with the same root form (such as open and opened). The method thus looks for a pair of words in the knowledge base sequence which matches two sequential words in the preliminary agent sequence AWL that may be spaced by one or more phonemes that are yet to be transcribed. For each matched pair of words found inside the knowledge base 22, the method includes keeping as candidates, only those sequences WordSeq of words in the KB where word i and word i+1 are separated no more than a predetermined maximum number k of words. k may be, for example, from 1 to 20. K may be at least 2 or at least 4, or up to 12. For example, if it is assumed that word recognition efficiency for the agent is around 60%, then k may be defined as a 10 word maximum. For each of the identified candidate sequences of words in the KB 22, a sequence WordSeq occurring in the knowledge base and spacing word i and word i+1 is stored. A fill the gap likelihood (probability) L that this sequence should be used to fill the gap between the words in the sequence AWL is computed by comparing the respective sequences of phonemes to determine if there is a threshold similarity between them (this step is discussed in further detail below).

As will be appreciated, to reduce computation, the search in the knowledge base for a solution description that includes word i and word i+1 may be limited to those cases where the two words are spaced, in the preliminary transcription, by at least one untranscribed phoneme. In other embodiments all pairs of words are considered, to facilitate the identification of a knowledge base solution description, or step of a solution description, that best matches the preliminary transcription.

Those candidates 152, 154 where the likelihood L is above a predetermined threshold T (e.g., T>70%), and/or the top K most probable (e.g., K is up to 10), are stored in a list LC of valid candidates, along with the related identifier (Sol-ID) of the solution description in the knowledge base where the word sequence 152, 154 was found and the sequence (WordSeq) 156 of missing words between Word i and Word i+1 retrieved from the KB. When the end of list of words AWL is reached, then each segment Word i-Word 1+1 is associated with a respective list of candidates. Given that the agent is reading from a specific solution description, then the solution ID should be the same all across the word segments in LC. The method therefore selects the solution description with the highest frequency and removes the others. The selection may also factor in the number of words that match and/or other parameters.

To compute the words for filling the gap and their likelihoods L, the method may proceed as shown in Algorithm 2:

Algorithm 2

ComputeFillGapLikelyhood (WordSeq) => (L, WordSeq, Sol-ID)

For each Word appearing in the sequence of words WordSeq
between Word i and Word i+1 do:

Retrieve for each Word all possible phonetic
transcriptions => ListPhKB

Retrieve from the list APL the sequence of Phonemes
ListPhAgent generated by the STT tool between time stamp
AWL-i-end and AWL-i+1-start
Attempt to align ListPhKB and ListPHAgent. Compute a
matching likelihood and if this likelihood is above a
given threshold T then return:

the Likelihood L,
the list of words WordSeq appearing in the KB
between Word i and Word i+1, and
the identifier of the solution in the KB where the
sequence comes from.

In more detail, the method for computing a word sequence and its probability for filling the gap includes, for each word appearing in the sequence of words WordSeq between Word i and Word i+1 in the KB sequence 152, 154, retrieving all possible phonetic transcriptions, and storing them in a list ListPhKB. Then, from the sequence APL, the sequence of phonemes ListPhAgent generated by the STT tool 60 between the time stamp AWL-i-end for the end of the first word in the pair of matching words and the timestamp AWL-i+1-start at the start of the next word in the pair, is retrieved. An alignment between ListPhKB and ListPHAgent is computed which generates the highest matching likelihood L and if the likelihood is above a given threshold T, then the likelihood L and the list of words WordSeq appearing in the KB between Word i and Word i+1 is output, together with the identifier of the solution 88 inside the KB from which the sequence 152 comes.

There are various ways in which the likelihood may be computed. It can be assumed that even if the sequence of words 152 from the knowledge base is effectively the one read by the agent, the transcription process into phonemes by the STT decoder 66 may not end into a sequence of phonemes 64 that is exactly the same for several reasons. These may include the agent's pronunciation being different from the official one, rephrasing of some parts of the solution description, and/or adding of complementary information by the agent.

To allow for such sources of variation, one way to compute the alignment likelihood is as follows:

Likelihood, L=(ΣMatch/ΣPhKB)−α(MaxGap/ΣPhA) (1)

where:

MaxGap=the longest gap (number of phonemes) between two matching phonemes;

ΣMatch=the number of matching phonemes between ListPhKB and ListPhAgent;

ΣPhKB=the number of phonemes in ListPhKB;

ΣPhA=the number of phonemes in ListPhAgent; and

α is a weight, which can be adjusted through evaluation of the accuracy/precision of the system. For example, α=1/10.

The computed likelihood L thus can take into account one or more of the number of matching phonemes, the maximum gap between pairs of matching phonemes, the number of phonemes in each phoneme sequence, and so forth.

As an example, given the following agent voice transcription 66, with each of unrecognized phonemes in a respective pair of brackets:

YOU [L] OPEN [DH] [L] [O] [ER] [B] [A] [K] DOOR

Assume that the text appearing in a solution of the KB is: open the back door.

The standard phonetic transcription of the words the back appearing in between open and door is: [Z or DH] [L] [OW] [ER] [B] [A] [K]. Using Eqn. 1 above, this gives a match with the respective unrecognized phonemes [DH] [L] [O] [ER] [B] [A] [K] from the voice transcription with a probability L=6/7−0.1*1/7=0.836. If T is 0.8, this probability would be above the threshold, so the words the back and the corresponding ID of the solution would be added to the list LC of likely candidates.

As will be appreciated, this method may not fill all the gaps in the agent transcription. However the method can reduce them at least for the solution description part (step d). In some embodiments, the same method may be applied to step b, as generally agents tend to reformulate the problem described by the user to make it correspond to a more standard way or to isolate some root causes. This corresponds to the way information typically appears in the knowledge base, where each problem is described in a standard way and a list of possible solutions is detailed. In some embodiments, the problem description 86 is additionally/alternatively used as a source of candidate sequences.

3. Transcription of What the User Says (S112, S116)

For this part of the conversation, the knowledge base may not be of great use in filling in the blanks in the preliminary transcription 68. However, in some cases, two or more communication channels are available at the same time. This means that the user can use the phone to discuss the problem directly with an agent or send an email or use a web chat. In this case, there are examples (in an electronic text format) of how users generally describe a specific type of problem. This information can be used as a reference to detect some of the terms that are generally used and match them to the unrecognized sounds left by the STT tool 60.

In the analysis of the agent's part of the dialogue (S114), the method outputs a probable solution ID. The identified solution ID is then used to retrieve the related cluster of questions, and therefore related list LFWPh of words (or short phrases) (along with their phonetic transcriptions) that are frequently used by users when describing a problem that has, as its solution, the solution corresponding to the identified solution ID.

A search is then made for any possible matches between LFWPh and sequences 150 of phonemes, generated by the STT tool on the user's speech, that are not related to a recognized word. Here the threshold for what is considered a match is lower than what would normally be applied by the SST tool, so a sequence which went unrecognized at S112 can be resolved if it is similar to one of the commonly used words or phrases. For example, an equation similar to Eqn. 1 can be used to compute similarity, which takes into account one or more of: the number of matching phonemes, the maximum gap between pairs of matching phonemes, the number of phonemes in each phoneme sequence, and so forth.

The matching sequences of phonemes are then replaced by the related word coming from the cluster of words frequently used by users to describe the problem.

As will be appreciated, users 18 are not constrained to the vocabulary in the knowledge base 22, and may use a variety of different words to describe the same problem. Accordingly, it is to be expected that the method for transcribing what the user says may not allow filling all the gaps in the preliminary transcription 68. However, since the decoder 60 often leaves a large number of user words untranscribed, even a relatively low success rate can provide significant improvements over the approximately 25% word recognition typical for user's speech.

As will be appreciated, the method described herein can be combined with other methods for improving speech to text transcription. The decoder 60 may be trained to recognize the agent's voice. A dedicated language model may be created for the specific domain, such as printers, which is then used by the decoder. This involves training the decoder to recognize the vocabulary and sequence of terms used. However, both these approaches are time consuming and also do not address the user's side of the conversation.

The present method leverages the existing problem and solution descriptions to attempt a phonetic alignment between the knowledge base content and the unrecognized words. This method uses the specificity of call center material to try to fill the gaps.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for speech to text transcription comprising:
providing access to a knowledge base containing solution descriptions, each solution description including a textual description of a solution to a respective problem;
generating a preliminary transcription of at least an agent's part of an audio recording of a dialogue between the agent and a user in which the agent had access to the knowledge base, the generating comprising:
identifying a sequence of phonemes based on the agent's part of the audio recording, and
based on the identified sequence of phonemes, generating the preliminary transcription, the preliminary transcription including a sequence of words recognized as corresponding to phonemes in the sequence of phonemes and unrecognized phonemes from the phoneme sequence that are not recognized as corresponding to one of the recognized words; and
revising the preliminary transcription, the revising comprising replacement of unrecognized phonemes with at least one word from a solution description, the solution description including words which match words of the sequence of recognized words,
wherein at least one of the generating of the preliminary transcription and the revising of the preliminary transcription is performed with a processor.

2. The method of claim 1, wherein revising the preliminary transcription comprises:
comparing recognized words in the preliminary transcription with words in solution descriptions in the knowledge base to identify candidate solution descriptions which each include a sequence of text which includes words which are determined to match at least some of the identified words in the preliminary transcription, and
using a phoneme sequence corresponding to a sequence of text in one of the candidate solution descriptions, replacing at least one of the unrecognized phonemes in the preliminary transcription with at least one word of the sequence of text in the candidate solution description which is aligned with the at least one unrecognized phoneme to generate a revised transcription.

3. The method of claim 2, wherein the comparing of recognized words in the preliminary transcription with words in the solution descriptions in the knowledge base to identify candidate solution descriptions comprises, for a pair of identified words in the preliminary transcription that are spaced by at least one unrecognized phoneme, determining whether a matching pair of words in a solution description is spaced by a gap of at least one word and comparing the at least one unrecognized phoneme with at least one phoneme corresponding to the at least one word in the gap to determine if there is a match.

4. The method of claim 3, wherein the gap between the matching pair of words in the solution description is permitted to be no more than a threshold size.

5. The method of claim 2, wherein the method includes determining whether there is one of the solution descriptions in the knowledge base which includes the matching pair of words for each of a plurality of pairs of identified words in the preliminary transcription that are spaced by at least one unrecognized phoneme and where the at least one unrecognized phoneme for each pair has at least a threshold similarity with a phoneme sequence corresponding to aligned words in the solution description.

6. The method of claim 2, wherein the comparing of recognized words in the preliminary transcription with words in solution descriptions in the knowledge base to identify candidate solution descriptions comprises, for each of first and second sequential pairs of recognized words in the preliminary transcription:
generating a first sequence of phonemes for the words that space two words of an identified solution description that match the sequential pair of recognized words;
computing a matching likelihood between the first sequence of phonemes and a second sequence of phonemes that temporally spaces the pair of matching words of the preliminary transcription;
determining if the matching likelihood meets a predetermined threshold;
where the threshold is met, storing the words appearing in the solution description between two matching words, and an identifier of the solution description; and
comparing the identifiers of the solution descriptions stored for the first and second sequential pairs of recognized words.

7. The method of claim 1, wherein the method further includes, prior to revising the preliminary transcription, associating text sequences of the solution descriptions in the knowledge base with respective sequences of phonemes.

8. The method of claim 1, wherein the method further comprises:
generating a preliminary transcription of a user's part of the audio recording of the dialogue between the agent and the user comprising:
identifying a sequence of phonemes based on the user's part of the audio recording, and
based on the identified sequence of phonemes, generating the preliminary transcription of the user's part, the preliminary transcription including a sequence of words recognized as corresponding to phonemes in the sequence of phonemes and unrecognized phonemes from the phoneme sequence that are not recognized as corresponding to one of the recognized words;
revising the preliminary transcription of the user's part, comprising:
retrieving an identifier of the solution description used in replacing the at least one of the unrecognized phonemes in the preliminary transcription of the agent's part;
retrieving phoneme sequences for a cluster of words associated in memory with the solution identifier; and
comparing the unrecognized phonemes in the preliminary transcription of the user's part with the phoneme sequence for each of words in the cluster of words to identify at least one matching word from the cluster of words; and
replacing at least one of the unrecognized phonemes in the preliminary transcription of the user's part with at least one matching word from the cluster of words.

9. The method of claim 8, wherein the cluster of words is derived from text communications from users which have been associated with the solution description identifier.

10. The method of claim 8, further comprising, for each of a plurality of the solution descriptions in the knowledge base:
processing text communications from a plurality of users to identify a cluster of words frequently used in a cluster of the text communications that has been associated with the solution description; and
associating each of the frequently used words with a respective sequence of phonemes.

11. The method of claim 1, further comprising outputting at least one of the revised transcription and information based thereon.

12. The method of claim 1, wherein each solution to a respective problem relates to a solution to a problem with a device.

13. The method of claim 1, further comprising automatically identifying a first part of the audio recording of the dialogue between the agent and the user as the agent's part and a second part of the audio recording of the dialogue between the agent and the user as the user's part.

14. The method of claim 13, wherein the agent's part and the user's part are processed differently.

15. The method of claim 1, wherein the phonemes are drawn from a finite alphabet.

16. A computer program product comprising a non-transitory recording medium storing instructions, which when executed on a computer causes the computer to perform the method of claim 1.

17. A system comprising memory which stores instructions for performing the method of claim 1 and a processor in communication with the memory for executing the instructions.

18. A system for speech to text transcription comprising:
a speech to text decoder for generating a preliminary transcription of at least an agent's part of an audio recording of a dialogue between the agent and a user, the agent having access to an associated knowledge base of solution descriptions, each solution description including a textual description of a solution to a respective problem, the decoder configured for:
identifying a sequence of phonemes based on the agent's part of the audio recording, and
based on the identified sequence of phonemes, generating the preliminary transcription, the preliminary text transcription including a sequence of words recognized as corresponding to phonemes in the sequence of phonemes and unrecognized phonemes from the phoneme sequence that are not recognized as corresponding to one of the recognized words;
a revision component for revising the preliminary transcription, the revision component configured for:
comparing recognized words in the preliminary transcription with words in solution descriptions in the knowledge base to identify candidate solution descriptions which each include a sequence of text which includes words which are determined to match at least some of the identified words in the preliminary transcription, and
using a phoneme sequence corresponding to a sequence of text in one of the candidate solution descriptions, replacing unrecognized phonemes in the preliminary transcription with at least one word of the sequence of text in the candidate solution description to generate a revised transcription; and
a processor which implements at least one of the generating of the preliminary transcription and the revising of the preliminary transcription.

19. The system of claim 18, further comprising the knowledge base of solution descriptions, each solution description being associated in memory with a phoneme sequence corresponding to text of the solution description.

20. A method for providing a system for speech to text transcription comprising:
with a processor, for each of a set of solution descriptions in a knowledge base which includes a textual description of a solution to a respective problem with a device, associating the solution description with a sequence of phonemes corresponding to at least a part of the textual description;
providing access to a speech to text converter which is configured for generating a preliminary transcription of at least an agent's part of an audio recording of a dialogue between the agent and a user in which the agent has access to the knowledge base, the generating comprising:
identifying a sequence of phonemes based on the agent's part of the audio recording, and
based on the identified sequence of phonemes, generating the preliminary transcription, the preliminary transcription including a sequence of words recognized as corresponding to phonemes in the sequence of phonemes and any unrecognized phonemes from the phoneme sequence that are not recognized as corresponding to one of the recognized words; and
providing instructions for revising the preliminary transcription when there are unrecognized phonemes from the phoneme sequence, the instructions providing for replacement of unrecognized phonemes with text from a solution description which includes words from the sequence of recognized words.
